(19) United States
(12) Patent Application Publication
(10) Pub. No.: US 2003/0177054 A1
(43) Pub. Date: Sep. 18, 2003

(54) Generating marketing information for non-purchased items of a gift registry

(76) Inventors: Russell J. Reinbold, Plymouth, MN (US); Scott T. Lidberg, Dellwood, MN (US)

Correspondence Address: SHUMAKER & SIEFFERT, P. A., 8425 SEASONS PARKWAY, SUITE 105, ST. PAUL, MN, 55125, US

(21) Appl. No.: 10/097,068

(22) Filed: Mar. 12, 2002

(51) Int. Cl. G06F 17/60

(52) U.S. Cl. 705/10

(57) ABSTRACT

The invention is directed to techniques for generating marketing information based on non-purchased items of a gift registry. A system is described that includes a database to store data identifying items registered by a customer in a gift registry. The data identifies whether the items of the registry have been purchased. A generation module generates marketing information for a customer based on the data. A data-mining module selectively retrieves the data from the database, and communicates the data to the generation module. The data-mining module selects items from the registry, and possibly non-registry items, based on a variety of factors, such as retail cost of the items, profit margin of the items, a manufacturer of the items, customer loyalty data, and a profile of the customer that may include demographic information as well as spending pattern data for the customer.

### FIELD

The invention relates to marketing, and more particularly, to focused marketing techniques for registered products.

### BACKGROUND

Retailers often use gift registry programs to facilitate and enhance the gift-giving process for various events. For example, an engaged couple may register in a bridal registry program to help insure that friends and family purchase gifts that are desirable to, or needed by, the couple. The couple may register at one or more retailers by selecting from each retailer a list of desirable products or services. Friends and family can access the lists and select items to purchase for the couple. When a person purchases an item listed on the gift registry, that retailer may delete the item from the list, or conspicuously indicate on the registry that the gift has been purchased. In this manner, duplicate purchases of items can be avoided.

Gift registry programs can be used for a wide variety of events, such as weddings, anniversaries, holidays, birthdays, graduations, bridal showers, baby showers, bar mitzvahs, religious confirmations, or the like. Because gift registry programs allow the recipient to specify desirable gifts, both the recipient and the purchaser of the gift appreciate the programs. Accordingly, gift registry programs can reduce wasteful spending on unneeded or undesirable gifts.

In many cases, at least some of the gifts listed in the registry are not purchased. For example, the registered list of products may be relatively expansive to provide gift-givers with a number of choices, possibly in a number of different price ranges. Often, the number of products in the registered list may be larger than the number of invitees to the event. Thus, even after the gift-giving event, the recipient may still need or desire items on the list that were not purchased.

### SUMMARY

In general, the invention is directed to techniques for generating marketing information for non-purchased items of a gift registry. When registering in a gift registry program for a gift-giving event, customers typically identify items that they need or desire. Therefore, the customer often still needs or desires non-purchased items remaining on the gift registry. For this reason, generating focused marketing information for the non-purchased items, such as generating marketing certificates for the non-purchased items, can be a very effective marketing strategy. The marketing certificates may, for example, offer the customer discounts on the purchase of one or more of the non-purchased items.

In one embodiment, the invention is directed to a technique that includes generating marketing information for a customer based on a list of non-purchased items of a gift registry. The method may further comprise communicating the marketing information to the customer to solicit future business. In addition, as outlined in detail below, a wide variety of additional techniques may be implemented to focus the marketing information in a manner that can increase sales, profit, or both, of retail establishments, product manufacturers, or possibly the provider of the marketing service. Predictive techniques may be used to generate the marketing information based on a variety of criteria, including a customer profile including demographic information and purchase patterns, customer loyalty data, data from other gift registries, non-registry items that may be related to the items of the gift registry or that the customer may be likely to purchase, and the like. In addition, generating the focused marketing information may provide benefits to the customer in the form of discounts or incentives to purchase items that the customer likely needs or desires.

The described techniques may be implemented hardware, software, firmware, or any combination thereof. If implemented in software, the techniques may be directed to a computer-readable medium comprising program code that, upon execution, performs one or more of the techniques described herein. For example, the program code may be stored on the medium as machine-executable instructions or commands. In some embodiments, the invention is directed to a system in which the described techniques are performed.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is a flow diagram that provides a high-level overview of techniques for generating focused marketing information from non-purchased items of a gift registry.

FIG. 2 is a block diagram illustrating an example system in which a central marketing provider generates focused marketing information according to the principles of the invention.

FIG. 3 is block diagram illustrating in further detail one embodiment of the system illustrated in FIG. 2.

FIG. 4 is another block diagram illustrating in farther detail another embodiment of the system illustrated in FIG. 2.

FIG. 5 is a flow diagram that provides another high-level overview of the principles of the invention.

FIG. 6 illustrates exemplary marketing information in the form of an exemplary marketing certificate according to an embodiment of the invention.

FIG. 7 illustrates an exemplary page of marketing certificates for a number of different items.

### DETAILED DESCRIPTION

In general, the invention is directed to various techniques for automatically generating marketing information for non-purchased items of a gift registry. The marketing information may take a variety of forms, and may include information for the non-purchased items as wells as related items that a customer would be likely to purchase. The techniques make use of the fact that when a customer registers items in a gift registry, the customer is providing valuable insight to his or her product needs and preferences. Accordingly, focused marketing directed at the customer for items that remain non-purchased for the customer following the gift-giving event associated with the gift registry may have a high likelihood of marketing success. Furthermore, the customer can benefit from the discounts or other purchasing incentives that relate specifically to items that the customer registered in the gift registry, but did not receive.

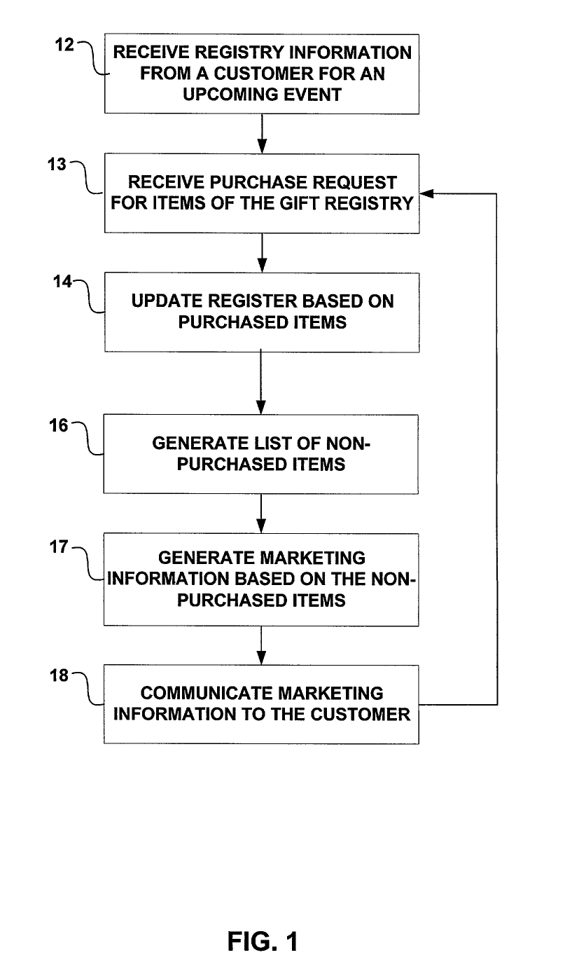

FIG. 1 is a flow diagram that provides a high-level overview of techniques for generating focused marketing information from non-purchased items of a gift registry. Initially, one or more retailers receive registry information from a customer registering for an upcoming event (12). The customer may, for example, visit one or more retail establishments to register their gift registries, or may register online via gift registries provided at web sites of the retailers via the Internet. To register, the customer typically selects a set of items offered by each retailer that he or she desire to receive as gifts for the upcoming event. The customer typically provides other information, such as the name of the customer and a description and date for the event. In addition, the customer may be required or may be requested to provide additional demographic information about the customer. Indeed, as outlined in greater detail below, additional information about the customer may provide a valuable marketing tool for marketing items to the customer after the event.

As used herein, “event” generally refers to any gift-giving event for which a customer may register at a gift registry. Typical examples of gift-giving events include weddings, anniversaries, holidays, birthdays, graduations, bridal showers, baby showers, bar mitzvahs, religious confirmations, or the like. However, the invention is not limited to any specific type of event, but is readily applicable for use with any gift-giving event for which the customer registers in a gift registry.

Furthermore, the term “customer” refers to the person or persons that register in the gift registry. Accordingly, in some cases, the term customer may refer to a number of persons that collectively register in the gift registry. For example, the customer may refer to an individual, a family, a team, a married or engaged couple that register in the gift registry for an event, or the like.

After receiving the registry information (12), purchase requests are received for gifts listed on the gift registry (13). In other words, persons invited to the event (invitees) purchase gifts for the customer based on the gift registry. The invitees may access the list of gifts registered by the customer in the gift registry in order to select gifts desired by the customer. Upon receiving order requests for gifts listed on the gift registry, (13), the retailer updates the registry to reflect the purchases (14). In other words, when an invitee purchases a gift listed on the registry, the retailer may remove the gift from the list, or update the registry to conspicuously mark the gift as being purchased in order to reduce the possibility of duplicate gifts.

Next, the gift registry is analyzed to automatically select some or all of the non-purchased items (16). The non-purchased items may comprise, for example, the items of the registry that remain non-purchased in the gift registry. This list of non-purchased items can be a powerful marketing tool because it is generally known that the customer desires the items. In addition, because invitees did not purchase the items, there is a high probability that the customer still needs or desires the non-purchased items. As described in further detail below, predictive techniques may be used to select the non-purchased items, and possibly non-registry items, based on a variety of criteria, including a customer profile that may include demographic information and purchase patterns, customer loyalty data, data from other gift registries, and the like. The non-registry items may be related to the items of the gift registry, or they may simply be items identified as items that the customer is likely to purchase.

Accordingly, highly effective marketing can be achieved by generating marketing information for the customer based on the list of non-purchased items (17). Marketing certifications offering discounts for the non-purchased items, for example, may be generated. In many cases, a series of certificates can be generated over time, and the marketing certificates may include discounts for a number of items (possibly all of the items) that remain on the list of non-purchased items. In addition, the marketing information may describe items related to items on the list, and may also include general product literature.

As described below, the generated marketing information may be focused based on a number of factors to select a subset of the non-purchased items remaining on the registry and possibly other items. After generating the list of non-purchased items, the marketing information can be communicated to the customer (18) in order to encourage the customer to purchase one or more of the non-purchased items.

Upon receiving the focused marketing information, the customer may elect to purchase one or more of the items described by the marketing information. Accordingly, the retailer may receive purchase requests for items on the gift registry (13) and, based on the requests, further updates the registry (14). Consequently, a new list of non-purchased items and corresponding marketing information can be generated and communicated to the customer (16,17,18).

In this manner, the process of generating focused marketing information repeats, and can intelligently select and market non-purchased items based on a variety of factors. In particular, one or more of a number of factors can be used to assess and identify effective strategies for generating the marketing information from the list of non-purchased items. For example, historical data accumulated within the gift registry can be mined in order to assist in generating the list of non-purchased gifts. In addition, data representing purchasing trends associated with a time frame following different events can be accumulated and then used to form useful marketing strategies and techniques. For example, statistical analysis may reveal that the customer is more likely to purchase household goods immediately after an event such as a marriage ceremony or baby shower. Accordingly, purchase probabilities may be assigned to the non-purchased items, and a subset of the items may be selected from which to generate the marketing information.

In addition, information provided by the customer at the time of registration can be used to create a marketing profile of the customer for use when selecting the non-purchased gifts. Other factors that may be used to selectively generate the list of non-purchased goods and corresponding marketing information includes the costs of the various non-purchased items or the profit margin of various non-purchased items can also be weighed. For example, data analysis may determine that a customer is more likely to purchase lower cost goods shortly after an event. Alternatively, higher profit-margin gifts may be selected for the initial marketing information, which subsequent focused marketing communications addressing lower profit-margin gifts. Other criterion includes the manufactures of various non-purchased items remaining on the gift registry. For example, a retailer or a provider of the registry mining and marketing service may elect to market only those non-purchased items that are manufactured by manufacturers that have agreed to pay for the service, or otherwise contribute to the cost of producing the marketing information.

Additional marketing strategies can be developed based on the factors listed above, and possibly other factors, as outlined in greater detail below. For example, if the customer registers in a number of gift registries, non-purchased items can be selected from the registries to form aggregated marketing information. In addition, the non-purchased items from the multiple registries may be weighted according to an amount of time that has elapsed since the respective registration.

Furthermore, the nature of the event itself may be used to predict future purchasing trends. For example, in the years following a marriage, it may be desirable to market non-purchased items form gift registries that newlyweds are likely to purchase. Similarly, in the months and years following a baby shower, items associated with newborn babies or toddlers can be marketed to the customer. By assessing the nature of the event and using a known time of when the event occurred (as indicated by the customer during registration in the gift registry) subsequent “likely to occur events” can be predicted. Accordingly, marketing techniques based on the likely to occur events may also be very effective.

In various different embodiments, aspects of the invention may be implemented solely by a retail establishment, or by any provider of a registry program. However, in the embodiments outlined in greater detail below, a marketing provider implements many aspects of the invention. For example, the marketing provider may offer software systems and marketing services to help retail establishments leverage their registry programs. In that case, the marketing provider may utilize the Internet or proprietary networks as an environment for the software systems and the marketing services. Nevertheless, it is understood that many of the same or similar techniques can be utilized directly by the retail establishments themselves.

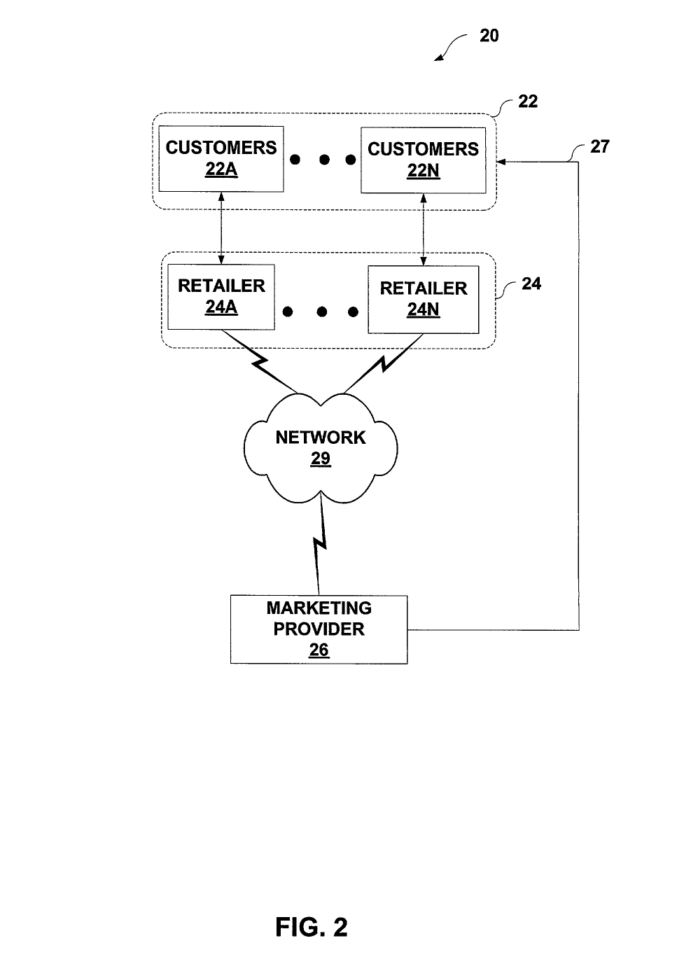

FIG. 2 is a block diagram illustrating an example system 20 in which a central marketing provider 26 generates focused marketing information according to the principles of the invention. In particular, marketing provider 26 offers various software systems and marketing services to one or more retailers 24A-24N (collectively referred to as retailers 24) to automatically generate focused marketing information from gift registries of respective customers 22A through 22N, collectively referred to as customers 22. Retailers 24 generally represent business entities that offer gift registry programs to their customers 22. For example, retailers 24 may include one or more traditional retail establishments, one or more e-commerce retailers and the like. Retailers 24 operate gift registry programs to facilitate and enhance the gift-giving process for various different gift-giving events. In some cases, the gift registry programs offered by retailers 24 may be different programs for the different retailers, and in other cases, two or more of retailers 24 may offer a combined registry program in which a common list of items is maintained and updated for the two or more retailers 24.

Marketing provider 26 generally represents a business entity that offers various marketing services to retailers 24 based on the registry programs of the retailers 24. For example, as outlined in greater detail below, data accumulated by retailers 24 during operation of the gift registry programs can be mined in order to establish focused marketing techniques directed toward the customers 22 that register in the gift registry programs.

In the simplest case, marketing provider 26 may simply receive from retailers 24 via network 29 data that identifies non-purchased items for registries of customers 22. Marketing provider 26 may generate marketing information 27 based on the lists of non-purchased items, and can communicate the marketing information 27 to the customers 22. Marketing provider 26 may communicate marketing information 27 to customers 22 using any number of services such as regular mail, electronic mail via network servers, and other services. As described in detail below, marketing providers may make use of systems to implement more complex marketing techniques by accumulating and mining data associated with gift registry programs of retailers 24. For example, marketing provider 26 may employ data-mining and predictive techniques to generate marketing information 27 based on a variety of criteria, such as a customer profile including demographic information and purchase patterns, customer loyalty data, data from other gift registries, data describing non-registry items that may be related to the items of the gift registry or that the customer may be likely to purchase, and the like.

Network 29 represents any communication link suitable for communicating data. For example, network 29 may represent point-to-point communication link between marketing provider 26 and retailers 24, a local area network, a wide-area network, or a global computer network like the Internet. The “Internet” is a well-known term that refers to collection of networks that utilizes layered protocols to route packets of data to various locations around the world. Dividing the data into packets has several advantages including enabling the sending device to resend only those individual packets that may be lost during transmission. Packets are communicated according to a layered communication protocol that defines the format of the packet and the route that the packet takes during transmission. A typical packet, for example, includes a header carrying source and destination information, as well as a payload that carries the actual data. The de facto standard for communication in packet-based networks, including the Internet, local area networks or wide area networks is Transmission Control Protocol/Internet Protocol (TCP/IP). In some cases, transmission of data files between retailers 24 and marketing provider 26 may take place via one or more file transfer protocols (FTP).

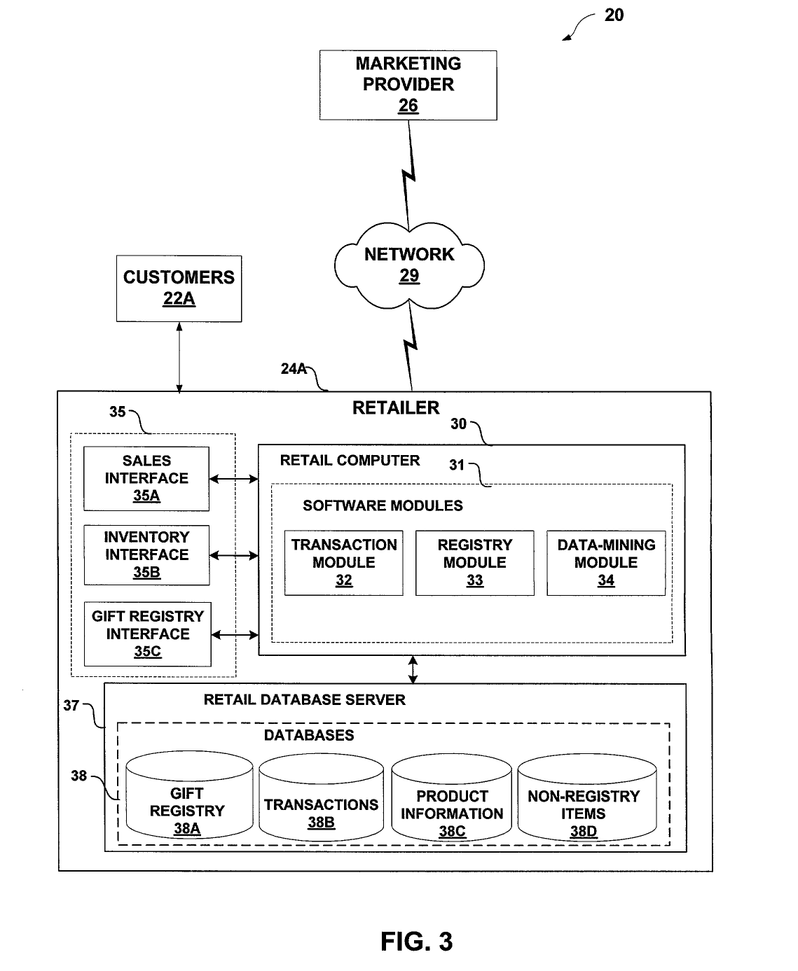

FIG. 3 is block diagram illustrating in further detail one embodiment of the system 20 illustrated in FIG. 2. In particular, FIG. 3 provides a more-detailed view of one embodiment of one of retailers 24, such as retailer 24A. As shown, retailer 24A includes a retail computing system 30 for managing and operating various tasks of retailer 24A. Retail computing system 30 may comprise one or more servers that executes server software such as, UNIX, LINIX, Microsoft Windows® Server software available from Microsoft Corporation, of Redmond, Washington, MAC OS X™ Server software available from Apple Computer Inc. of Cupertino, California, or web server software such as Internet Information Server™ also available from Microsoft Corporation. Retail computing system 30 provides an environment for interacting with customers and employees of retailer 24A according to software modules 31. For example, various software modules 31 may be embodied in software languages such as, for example, C, C++, Java, Basic, Visual Basic, Fortran, and the like, or web page software such as hypertext markup language (HTML) or dynamic HTML, extensible markup language (XML), predictive modeling markup language (PMML), personalized page markup language (PPML), Active X modules, Lotus scripts, Java scripts, Java Applets, Flash, Distributed Component Object Modules (DCOM), and the like. It is understood however, that the techniques embodied in software modules 31 could alternatively be embodied in hardware, firmware, or combinations of hardware, software and firmware.

Software modules 31 interact with retail database server 37 to access and update a number of databases 38. Each database 38 maybe implemented in a number of different forms including a data storage file, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management systems. Furthermore, although illustrated separately, different databases 38 could be combined into a single database or other data storage structure. Databases 38 could, for example, be implemented as a single relational database such as SQL Server™ from Microsoft Corporation.

Retail computing system 30 may also be coupled to one or more interfaces 35. For example, sales interface 35A may comprise a cashier station at which an employee of retailer 24A performs sales transactions, such as scanning bar codes and receiving payment from the purchaser. Sales interface 35A may also be an automated interface, for example using bar code technology or radio frequency identification (RFID) technology. Sales interface 35A may alternatively comprise a web interface if, for example, retailer 24A is an e-commerce retailer.

Transactions may take place at sales interface 35A according to transaction module 32. Transaction module 32 may update or store sales transaction information in transactions database 38B. For example, when an item is purchased, a bar code can be scanned or an RFID tag can be read. The purchaser may pay for the item, and some of the information relating to the transaction can then be stored in customer transactions database 38B. In addition, transaction module 32 may update product information database 38C to maintain a real-time estimate of inventory.

Retailer 24A may also include an inventory interface 35B, coupled to retail computing system 30, such as an interface located at a loading and receiving dock. In some cases, inventory interface 35B can be embodied in one or more wireless terminals that facilitate inventory management. Product information of the products sold by retailer 24A, including product prices, price margins, sales trends or histories, sales incentives, inventories, and the like, may be stored in product information database 38C. For example, the product information may be entered or updated when inventory is received and when transactions occur. Received inventory may be entered via inventory interface 35B, for example, at a loading and receiving dock of retailer 24A. Inventory can also be monitored as transactions occur at sales interface 35A. In this manner, product information can be stored and updated within product information database 38C.

Retailer 24A may also include a gift registry interface 35C coupled to retail computing system 30. In particular, gift registry interface 35C may include an interface for a customer 22 to register a list of items or for an invitee to access a registered list. For example, a customer 22 may access a gift registry program via gift registry interface 35C. The gift registry program may operate according to registry module 33. In various embodiments, registry module 33 can be programmed to require the customer to enter various information to register in the gift registry program, either at a retail location or via the Internet. This required information may include the name of the customer, the gift-giving event, the time that the event is to take place, and a list of items that the customer would like to receive. The gift registry information entered by the customer can be stored in gift registry database 38A. Additional personal information may also be required or requested when the customer registers. For example, the customer may be required or requested to fill out a questioner or otherwise provide information about the customer or the preferences of the customer. This additional information can also be stored in gift registry database 38A.

Invitees to the gift-giving event can access the list of gifts provided by the customer via gift registry interface 35C. For example, at gift registry interface 35C, an invitee may access the list of items provided by the customer simply by identifying the customer or by identifying the event. In either case, registry module 33 can access from gift registry database 38A, the list of items provided by the customer, and can display or print the list for the invitee. If the invitee purchases an item from the list for the customer, then the list can be updated by either deleting the purchased item from the list or by conspicuously marking the item as being purchased. For example, the invitee may indicate at gift registry interface 35C that he or she is going to purchase an item. Alternatively, the invitee may indicate this fact to a sales clerk during check out. In either case, the fact that the item was purchased for the customer can be recorded in gift registry database 38A in order to ensure that duplicative gifts are not purchased by a number of invitees.

In accordance with one embodiment of the invention, retail computing system 30 may also include a data-mining module 34 for mining databases 38 for items for which to generate marketing information. In particular, data-mining module 34 accesses data stored in databases 38 in order to generate marketing information for non-purchased items, non-registry items 3 8D, or any combination thereof, based on a variety of criteria. Non-registry items 38D may include data for products or services not registered for by the customers, but that the customers may likely purchase. The non-registry items 38D may, for example, describe items related to non-purchased items 47A. Data describing the selected items can be sent to marketing provider 26, across network 29 so that marketing provider can market items to the customer accordingly.

The detailed operations and various data-mining techniques performed by data-mining module 34 are outlined in greater detail below. In general, data-mining module 34 applies predictive logic to select a subset of the non-purchased items for the marketing information, one or more non-registry items, or any combination thereof, based on a variety of data maintained by databases 38, such as customer profile data, customer loyalty data, a purchase history for the customer, product pricing and other information, and the like. In practice, the data-mining techniques can be implemented within retailer 24A or alternatively within marking provider 26. However, in the later case, large amounts of information stored within databases 38 may need to be communicated from retailer 24A to marketing provider 26. Retailers 24, however, may be reluctant to release large amounts of proprietary customer information, pricing information, inventory information, and the like, to an outside marketing company, such as marketing provider 26. For this reason, it may be advantageous to perform some or all of the data-mining techniques with retailer 24A. In any case, the techniques described herein may readily be performed within retailers 24, marketing provider 26, or any combination thereof.

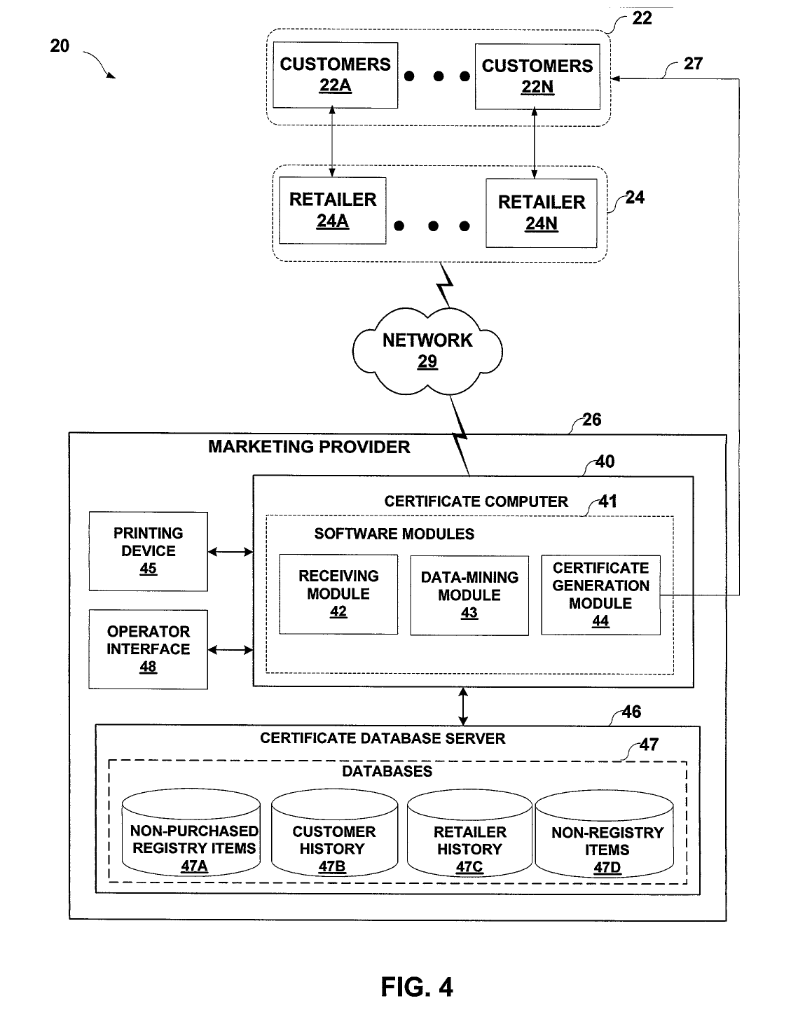

FIG. 4 is another block diagram illustrating in further detail another embodiment of system 20 illustrated in FIG. 2. In particular, FIG. 4 provides a more-detailed view of one embodiment in which marketing provider 26 performs many of the techniques for generating focused marketing information from gift registries of retailers 24.

As shown, marketing provider 26 includes a marketing computing system 40 for managing received information relating to registered product lists and generating marketing certificates based on non-purchased items of the product lists, non-listed items predicted to be well received based on analyzed data, or any combination thereof. Marketing computing system 40 may comprise a server that executes server software such as for example, UNIX, LINIX, Microsoft Windows® Server software available from Microsoft Corporation, MAC OS X™ Server software available from Apple Computer Inc., or web server software such as Internet Information Server™ also available from Microsoft Corporation. Marketing computing system 40 provides an environment for executing software modules 41 which can be programmed to perform various marketing tasks. The various software modules 41 may be embodied in software languages such as, for example, C, C++, Java, Basic, Visual Basic, Fortran, and the like, or web-page software such as hypertext markup language (HTML) or dynamic HTML, extensible markup language (XML), predictive modeling markup language (PMML), personalized page markup language (PPML), Active X modules, Lotus scripts, Java scripts, Java Applets, Flash, Distributed Component Object Modules (DCOM), and the like. Again, it is understood that the techniques embodied in software modules 41 could alternatively be embodied in hardware, firmware, or combinations of hardware, software and firmware.

Software modules 41 may interact with marketing database server 46 to access and update a number of databases 47. Each database 47 may be implemented in a number of different forms including a data storage file, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management systems. Furthermore, although illustrated separately, different databases 47 could be combined into a single database or other data storage structure. Databases 47 could, for example, be implemented as a single relational database such as SQL Server™ from Microsoft Corporation.

Marketing provider 26 can receive data from retailers 24 via network 29, such as data accumulated by retailers 24 during operation of the gift registry programs. For example, marketing provider 26 may receive data identifying non-purchased items for different customers 22 and possibly other customer information that customers 22 provided in the gift registry programs of retailers 24. Receiving module 42 may monitor and coordinate the reception of data from retailers 24. Upon receiving data, receiving module 42 can store the data in databases 47 according to the type of data received.

In the illustrated example, receiving module 42 can store data identifying non-purchased items in non-purchased items database 47A. Additional customer information, such as demographic information, can be stored in customer history database 47B. Transactional information from retailers 24 can be stored in retailer history database 47C. In this manner, marketing computing system 40 can make use of information that was accumulated by retailers 24 during operation of the gift registry programs to provide focused marketing toward the customers 22.

Marketing computing system 40 may include a data-mining module 43 to mine received customer data in order to create personalized marketing strategies focused on the needs and preferences of the customer. Alternatively, as illustrated in reference to FIG. 3, retailers 24 may perform the data-mining functions. In any case, marketing provider 26 generates focused marketing information 27 based on non-purchased items 47A, customer history 47B, retailer history 47C, and non-registry items 47D, or any combination thereof, based on a variety of criteria. Non-registry items 47D may include data for products or services not registered for by the customers, but that the customers may likely purchase. The non-registry items 47D may, for example, describe items related to non-purchased items 47A. Marketing provider 26 communicates the marketing information 27 to customers 22.

More specifically, generation module 44 and mining module interact to selectively retrieve and filter data from non-purchased items database 47A in order to enhance the marketing information 27 provided to the customers 22. Generation module 44 makes use of the filtered data to generate marketing information 27. An operator interface 48 may be coupled to marketing computing system 40 so that an operator can control, monitor, or manually modify the marketing information generation process.

Generation module 44 may include raster image processing (RIP) software to generate print data that can be sent to printing device 45. RIP software such as the Configurable PostScript Interpreter (CPSI), available from Adobe Systems Inc. of San Jose, Calif., or ScriptWorks®, available from Harlequin Limited of Waltham, Mass., are two examples. Printing device 45 may comprise any suitable printing device. For example, to achieve very high quality marketing certificates, printing device may comprise a high quality digital printing press. However, other printing devices could also be used.

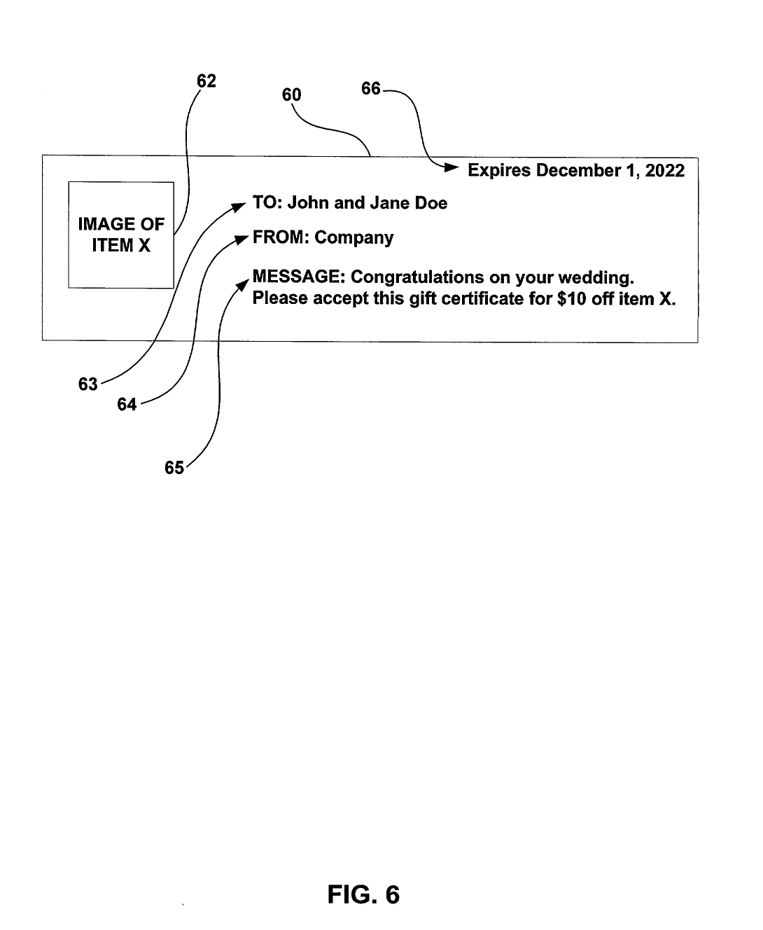

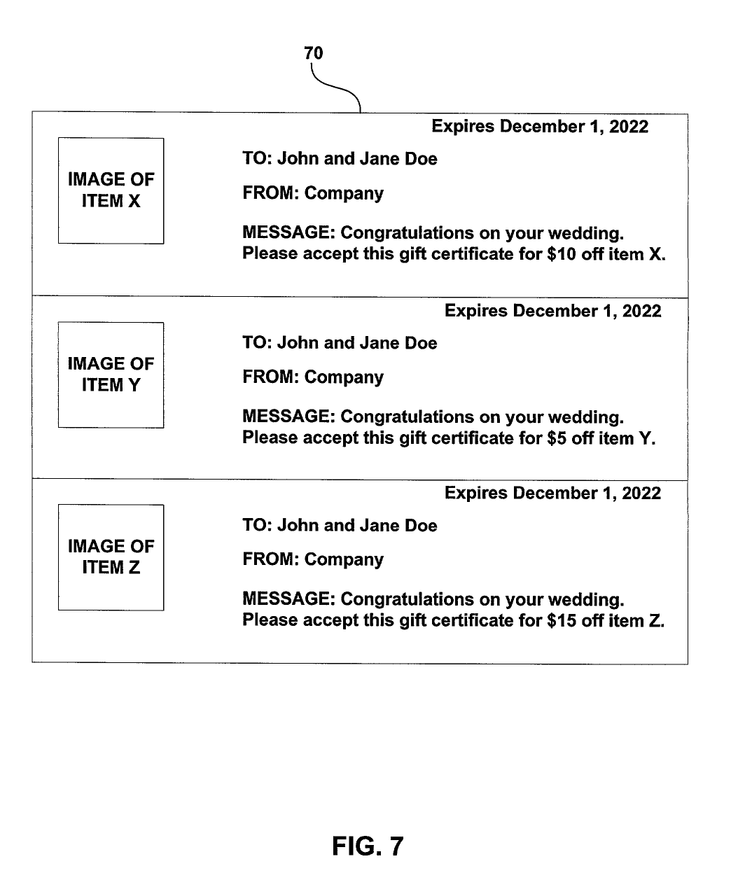

Printing device 45 prints the marketing certificates generated by generation module 44 so as to offer customer 22 discounts on items selected by data-mining module 43 as being good marketing candidates. In the simplest case, marketing information 27 may comprise discount certificates for items identified by non-purchased items 47A. FIG. 6 is a simplified illustration of one example of a marketing certificate, and FIG. 7 is a simplified illustration of an example page of marketing certificates. The features of the marketing certificates illustrated in FIGS. 6 and 7 are discussed in greater detail below.

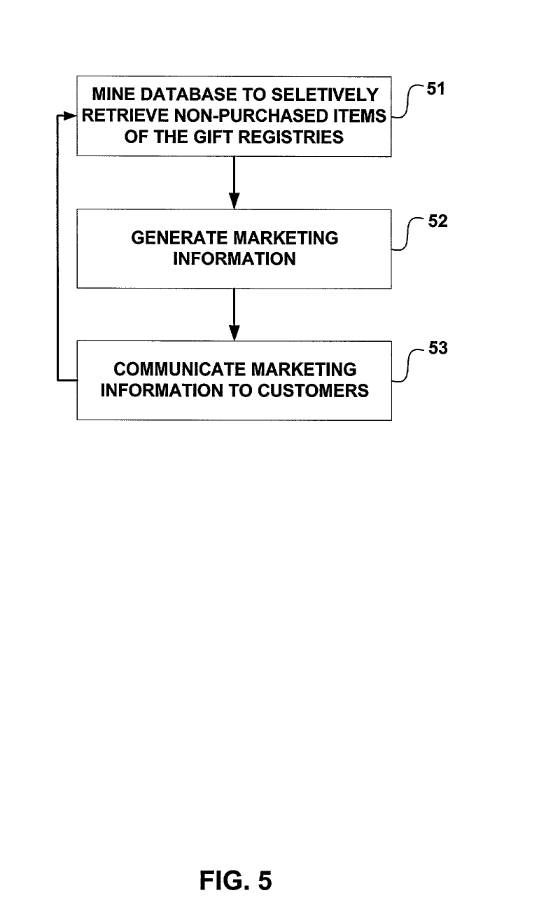

FIG. 5 is a flow diagram providing a high-level mode of operation of system 20 according to the principles of the invention. As shown, a data-mining module mines one or more database to select non-purchased items of gift registries of retailers 24, nonregistry items, or any combination thereof, based on a variety of criteria (51). For example, data-mining module 34 (FIG. 3) of retailer 24A can be used to internally mine data at the retailer 24A. Alternatively, retailers 24 may communicate gift registry data to marketing provider 26 to be mined by data-mining module 43 (FIG. 4) of marketing provider 26. Of course, the data can be first mined by data-mining module 34 of retailer 24A and the resultant data communicated to marketing provider 26 for further processing by data-mining module 43.

In one embodiment, data-mining modules 34 and/or 43 apply predictive logic to select non-purchased items, non-registry items, or any combination thereof, for which to generate the marketing information. For example, in addition to data identifying non-purchased items, data-mining modules 34, 43 may analyze vast amounts of additional information to predict customer behavior and select candidate non-purchased items from the gift registries. More specifically, data-mining modules 34, 43 can apply the prediction logic to formulate marketing strategies and techniques catered to select items that appeal to specific customers. The data accumulation process that takes place when customers 22 register in gift registry programs may be defined with these goals in mind. For example, when a customer registers for a gift registry, he or she may be asked or required to fill out additional questioners regarding his or her demographics. In some cases, the answers to the questioners can be used to formulate the parameters used in predictive behavior modeling.

Based on this analysis, data-mining modules 34, 43 may assign purchase probabilities to the items, and selectively identify non-purchased items or even non-registry items that the customer is “likely” to purchase. The likely purchased items may be identified based on the original list of items that the customer registered in the gift registry, the list of non-purchased items, profiles of the customer based on demographic information or spending patterns of the customer as tracked by retailers 24. In each case, marking provider 26 can generate marketing information 27 for the selected items based on the predictions.

The behavior modeling may continue over time, with additional information being provided each time the customers register in additional gift registry programs. For example, if a specific customer has registered in a number of gift registries, non-purchased items may be identified and selected from each registry. In that case, marketing information can be aggregated and sent to the customer. In addition, items that appear in more than one list and non-purchased items that correspond to more recent events may be given priority in the marketing scheme. In this manner, items may be selected for marketing from registries based on the number of times the customer registered for the items, the time that has elapsed since the customer registered for the items, and the time until that the respective event is scheduled to occur.

Moreover, the nature of the events themselves may be used to formulate parameters of the behavior modeling. For example, if the event is a wedding, then it is generally likely that the customer is indeed married following the event. In the years following a marriage, it may be desirable to market products to the customer that newlyweds are likely to purchase. Similarly, if the event is a baby shower, then an estimated time that the child will be born can be predicted. Accordingly, in the months and years following a birth, items associated with newborn babies or toddlers can be marketed to the customer. In general, by assessing the nature of the event and using a known time that the event occurred (as indicated by the customer during registration in the gift registry) subsequent “likely to occur events” can be predicted. Accordingly, focused marketing based on the likely to occur events can be used in generating marketing certificates at various points of time in the future.

Other information that can be used to improve the effectiveness of the marketing may include information about the items in the list of non-purchased items. For example, it may be desirable to give priority to the promotion of some specific items. In particular, items having higher retail costs or items that yield the highest profit margin may be given priority in the marketing scheme. Accordingly, marketing information focused on the higher priority items may be sent first, with other marketing information for other items being sent at later times.

Items may also be selected and marketed based on the manufacturer of the item. For example, retailers 24 or marketing provider 26 may offer manufacturers the option of paying to receive higher priority in the marketing scheme. In some cases, a number of mailings of marketing certificates can be made to customers 22. In that case, a first subset of items from the list of non-purchased items may be marketed to the customer first, and then a second subset of items from the list of non-purchased items may be marketed to the customer at a later time. These and additional mailings may focus on other likely to purchase items that are identified by the behavior modeling even though the items do not appear on the list of non-purchased items.

The response to the marketing information by customers 22 can also be monitored and recorded. For example, if a customer redeems a marketing certificate, the list of non-purchased items may be updated to reflect that fact. If more marketing certificates are sent, the updated list of non-purchased items may be used for the subsequent mailing. In addition, information describing items not on the registry but related to the purchased item may be included within the marketing information. For example, if the user redeems a marketing certificate to purchase a particular cookware, marketing information may be generated to include cookware from the same product line. Additionally, data-mining modules 34, 43 may track and use purchase data indicative of purchases by the customer for items not listed within the registry, and may include information for the items within the marketing information.

Customer loyalty is another criteria that data-mining modules 34, 43 can use in the mining process. For example, if marketing information is being generated for a specific one of retailers 24, customer loyalty data for that retailer may be considered. For example, it may be desirable to provide larger discounts to the more loyal customers, so as to reward the customer for the loyalty. Alternatively, it may be desirable to provide the larger discounts to the less loyal customers because the less loyal customers may require more incentives to conduct business with the given retailer.

As another criteria, data-mining modules 34, 43 may consider whether the customer has registered for a set of products. For example, the product set may include a set of related items, such as a set of pots and pans, or a bedroom or bathroom set. Often the items in the set can be purchased individually or collectively as a set. Therefore, if a customer has registered for a product set in a gift registry, but received only selected items from the product set, it would be highly advantageous to market only the other items in the set to the customer. Accordingly, data-mining modules 34, 43 may select items for inclusion within the marketing information for specific non-purchased items of a registered product set. In this manner, the customer may be motivated by the marketing certificate to complete the product set by purchasing the non-received items of the product set.

In addition, data-mining modules 34, 43 may consider non-registry items that the customer may be likely to purchase, and may include information for the non-registry items within the marketing information.

In one embodiment, data-mining modules 34, 43 implement a rule-based engine to assist in the processing of data and the selection of the items for inclusion within the marketing information. The rule-based engine may be implemented in any one of a variety of forms. The rules, for example, may be stored as logic data within a rules database. The engine may be implemented in LISP or any other suitable programming language, such as a predictive model markup language (PMML).

PMML is an XML-based language that can be used for creating predictive models of behavior based on various chosen data parameters. For example, PMML can be used to generate parameterized analytic models of probable customer behavior. In accordance with one aspect of the invention, the parameters can be selectively defined and chosen based on gift registry information provided by the customer when registering in a gift registry program. By parsing the data within PMML, for example, using a standard XML parser, customer behavioral models can be established to improve the effectiveness of marketing to that customer. In some cases, PMML can be used to generate a customer profile based on input parameters taken from data provided in the gift registry. Marketing toward the customer can then be focused based on the customer profile.

Once the gift registry data of retailer 24 has been mined (51), generation module 44 of marketing provider 26 generates marketing information (52), which may be displayed on operator interface 48 and/or printed by printing device 45. Marketing provider 26 then communicates the marketing information 27 to the targeted customers 22 (53). For example, printed marketing certificates may be sent to respective customers 22 via regular mail, or alternatively or additionally, the marketing information can be sent electronically to the customers 22, such as via electronic mail (email).

FIG. 6 illustrates exemplary marketing information in the form of a marketing certificate according to an embodiment of the invention. As illustrated marketing certificate 60 may include a number of different marketing features. For example, marketing certificate 60 may include a product description or brochure (not shown) for describing one or more marketed items, as well as an image 62 to provide an aesthetically pleasing illustration of the item. Marketing certificate 60 may also include an identifier of the recipient 63, as well as an identifier of the sender 64. A personalized message 65 and an expiration date 66 may also be included. Marketing certificate 60 may also include numerical codes, bar codes or RFID tags to facilitate automated use and verification.

Marketing certificate 60 may also identify that the particular one of customers 22 that is offered a discount on the purchase of the item. In the illustrated example, marketing certificate 60 provides a $10 discount on the purchase of item X. The discount may be provided as a retailer discount, a direct manufacturer discount, or even a discount provided by the marketing service provider 26. Marketing certificate 60 may be sent to the customer individually or as a collection. In either case, marketing certificate 60 may be included within a gift card that provides a personalized message, such as a congratulatory message to the customer.

FIG. 7 illustrates a collection of marketing certificates 70, such as in the form of a page of certificates. In accordance with the invention, the collection 70 may include certificates for a number of different items from the list of non-purchased items. The different certificates 70 may correspond to items manufactured by different manufacturers. In other words, the collection of certificates 70 may be defined by information relating to the customer, rather than the manufacturer of the various items. In this manner, personalized marketing for the customer can be achieved according to the customers needs and desires.

Various embodiments of the invention have been described. For example, various marketing techniques based on non-purchased items of a gift registry have been described. In addition, a number of data-mining techniques have been described for use in selectively marketing items to a customer that registers in gift registries. Nevertheless, it is understood that various modifications can be made without departing from the scope of the following claims.

1. A method comprising:
receiving data identifying items registered by a customer in a gift registry, wherein the data identifies whether the items of the registry have been purchased; and
generating marketing information based on the data.

2. The method of claim 1, further comprising communicating the marketing information to the customer.

3. The method of claim 1, wherein receiving data comprises receiving the data from one or more retailers.

4. The method of claim 1, further comprising:
receiving purchase requests for the items;
updating the data based on the purchase; and
generating new marketing information based the updated data.

5. The method of claim 1, further comprising:
receiving gift selection input from the customer; and
generating the data based on the gift selection input.

6. The method of claim 5, further comprising:
receiving demographic input from the customer; and
generating the marketing information based on the demographic information.

7. The method of claim 6, further comprising:
receiving data for non-registry items; and
generating the marketing information for a subset of the non-registry items and a subset of the non-purchased items of the registry.

8. The method of claim 7, further comprising selecting the subset of the non-registry items and the subset of the non-purchased items of the registry in accordance with at least one of a retail cost of the items, a profit margin of the items, a customer profile including demographic data and purchase pattern data, a manufacturer of the items, and customer loyalty data.

9. The method of claim 1, wherein generating marketing information comprises generating marketing certificates.

10. The method of claim 1, further comprising selecting a subset of the items for which to generate marketing information.

11. The method of claim 10, wherein selecting a subset of the items comprises selecting the subset of the items based on retail cost of the items.

12. The method of claim 10, wherein selecting a subset of the items comprises selecting the items based on profit margin of the items.

13. The method of claim 10, wherein selecting a subset of the items comprises selecting the items based on a manufacturer of the items.

14. The method of claim 10, wherein selecting a subset of the items comprises selecting the items based on a profile of the customer.

15. The method of claim 10, wherein selecting a subset of the items comprises selecting the items based on a loyalty data for the customer.

16. The method of claim 10, further comprising:
selecting a second subset of items from the data; and
generating additional marketing information for the customer based on second subset.

17. The method of claim 1, wherein the data identifies at least some items of a product set, and further wherein the non-purchased items includes some but not all of the items of the product set, and wherein generating marketing information comprises generating market information for the non-purchased items in the product set.

18. The method of claim 1, further comprising assigning customer purchase probabilities customer to the items.

19. The method of claim 18, further comprising generating marketing information for the identified items based on the assigned probabilities.

20. The method of claim 18, wherein assigning probabilities includes assigning probabilities to the purchased items.

21. The method of claim 18, wherein assigning probabilities includes assigning probabilities to the non-purchased items.

22. The method of claim 18, further comprising assigning the probabilities based on a profile of the customer.

23. The method of claim 1, further comprising generating marketing information for a customer based on spending patterns of the customer.

24. The method of claim 1, wherein the marketing information includes marketing certificates for products manufactured by a number of different manufacturers.

25. The method of claim 1, further comprising generating marketing information for a customer based data identifying non-purchased items registered by the customer in gift registries for a plurality of different events.

26. The method of claim 25, wherein generating the marketing information comprises selecting items based on dates for the different events.

27. The method of claim 1, wherein the marketing information includes marketing certificates that offer the customer discounts on one or more of the non-purchased items.

28. The method of claim 27, wherein the marketing certificates include images of the discounted items.

29. The method of claim 1, wherein the marketing information includes a congratulatory message to the customer.

30. A method comprising:
receiving data identifying non-purchased items of registry programs from one or more retail establishments;
selecting a subset of the items;
generating marketing information for the customer based on the selected subset of items; and
communicating the marketing information to the customer.

31. The method of claim 30, wherein selecting a subset of the items comprises selecting the subset of the items based on at least one of a retail cost of each item, a profit margin of each item, a manufacturer of each item, a profile of the customer, and loyalty data for the customer.

32. The method of claim 30, further comprising sending the marketing information to the customer via e-mail.

33. The method of claim 30, wherein selecting a subset of the items comprises assigning probabilities of purchase by the customer to the items.

34. The method of claim 30, further comprising:
receiving demographic information about the customer; and
generating the marketing information for the customer based on the demographic information.

35. A computer-readable medium comprising program code that generates marketing information for a customer based on registry data, wherein the registry data identifies items registered by a customer in a gift registry, and identifies whether the items of the registry have been purchased.

36. The computer-readable medium of claim 35, further comprising program code to communicate the marketing information to the customer.

37. The computer-readable medium of claim 35, further comprising program code to receive the registry data from one or more retail establishments.

38. The computer-readable medium of claim 35, further comprising program code that generates the registry data by tracking purchases of the items and updating the registry data.

39. The computer-readable medium of claim 35, further comprising program code that receives gift selection input from the customer, and generates the registry data based on the gift selection input.

40. The computer-readable medium of claim 35, further comprising program code to select a subset of items for which to generate marketing information.

41. The computer-readable medium of claim 40, further comprising program code to select the subset based at least one of a retail cost of each of the items, a profit margin of each of the items, a manufacturer of each of the items, and a profile of the customer.

42. The computer-readable medium of claim 35, further comprising program code to receive purchase requests for the items, update the registry data, and generate marketing information for the customer based on the updated registry data.

43. The computer-readable medium of claim 35, wherein at least some of the non-purchased items belong to a product set, the medium further comprising program code that generates marketing information for the non-purchased items in the product set.

44. The computer-readable medium of claim 35, further comprising program code that assigns purchase probabilities to the items and generates the marketing information for the customer based on the purchase probabilities.

45. The computer-readable medium of claim 44, further comprising program code to assign the purchase probabilities based on a profile of the customer.

46. The computer-readable medium of claim 35, further comprising program code that generates the marketing information to include marketing certificates for the identified items.

47. The computer-readable medium of claim 35, further comprising program code to generate the marketing information for the customer based on spending patterns of the customer.

48. A system comprising:
a database that data identifying items registered by a customer in a gift registry, wherein the data identifies whether the items of the registry have been purchased; and
a generation module that generates marketing information for a customer based on the data.

49. The system of claim 48, further comprising a data-mining module that selectively retrieves the data from the database, and communicates the data to the generation module.

50. The system of claim 49, wherein the data-mining module selects items based on retail cost of the items.

51. The system of claim 49, wherein the data-mining module selects items based on profit margin of the items.

52. The system of claim 49, wherein the data-mining module selects items based on a manufacturer of the items.

53. The system of claim 49, wherein the data-mining module selects items based on a profile of the customer.

54. The system of claim 49, wherein the database stores information about the customer, and wherein the data-mining module selects items based on the information.

55. The system of claim 49, wherein the data-mining module predicts likely to purchase items and selects items based on the likely to purchase items.

56. The system of claim 49, further comprising a printing device that prints the marketing information as marketing certificates.

57. A system comprising:
a receiving module that receives data identifying items registered by a customer in a gift registry, wherein the data identifies whether the items of the registry have been purchased;
a database that stores the data;
a data-mining module that selectively retrieves the data from the database;
a generation module that generates marketing information for a customer for the selected items; and
a printing device that prints the marketing information.

58. The system of claim 57, wherein the data-mining module selects items based on retail cost of the items.

59. The system of claim 57, wherein the data-mining module selects items based on profit margin of the items.

60. The system of claim 57, wherein the data-mining module selects items based on a manufacturer of the items.

61. The system of claim 57, wherein the data-mining module selects items based on a profile of the customer.

62. The system of claim 57, wherein the database stores information about the customer, and wherein the data-mining module selects items based on the information about the customer.

63. The system of claim 57, wherein the mining module assigns purchase probabilities to the items and selects the items based on the probabilities.
